(19) United States
(12) Patent Application Publication
(10) Pub. No.: US 2015/0354425 A1
(43) Pub. Date: Dec. 10, 2015

(54) HEATING ELEMENT FOR REDUCTANT TANK

(71) Applicant: Caterpillar Inc., Peoria, IL (US)

(72) Inventors: Jason W. Hudgens, Washington, IL (US); Matthew Fahrenkrug, Chillicothe, IL (US)

(21) Appl. No.: 14/298,210

(22) Filed: Jun. 6, 2014

(51) Int. Cl. F01N 3/20; H05B 3/82

(52) U.S. Cl. CPC F01N 3/2013; H05B 3/82

(57) ABSTRACT

A removable heating element is disclosed. The removable heating element includes a resistive filament. The removable heating element also includes a housing. The housing is connected to the resistive filament. The housing is configured to be coupled to a drain port of a reductant tank. The removable heating element also includes a receptacle provided on the housing. The receptacle is configured to be connected to an external power supply.

### TECHNICAL FIELD

The present disclosure relates to a heating element, and more particularly a supplemental heating element for a reductant tank.

### BACKGROUND

An aftertreatment system is associated with an engine system. The aftertreatment system is configured to treat and reduce NOx and/or other compounds of the emissions present in an exhaust gas flow, prior to the exhaust gas flow exiting into the atmosphere. In order to reduce NOx, the aftertreatment system may include a Selective Catalytic Reduction (SCR) module and a reductant delivery module.

The reductant delivery module includes a tank for storing a reductant, a pump, and reductant delivery lines. The reductant may include diesel exhaust fluid. The reductant is susceptible to freezing at temperatures of approximately −11° C. A heating system is associated with the tank in order to thaw the reductant therein.

U.S. Pat. No. 6,901,748 discloses a diesel engine having a selective catalytic reduction system with a urea tank. A heater element is mounted in the urea tank and another heating element is mounted in the engine for cold weather starts. Both heating elements are connected to a common cord which has at its distal end a common electrical plug for plugging into an electrical receptacle.

### SUMMARY OF THE DISCLOSURE

In one aspect of the present disclosure, a removable heating element is disclosed. The removable heating element includes a resistive filament. The removable heating element also includes a housing. The housing is connected to the resistive filament. The housing is configured to be coupled to a drain port of a reductant tank. The removable heating element also includes a receptacle provided on the housing. The receptacle is configured to be connected to an external power supply.

In another aspect of the present disclosure, an aftertreatment system is disclosed. The aftertreatment includes a reductant tank. The aftertreatment system also includes a coolant heater associated with the reductant tank. The coolant heater is configured to circulate a coolant through the reductant tank. The aftertreatment further includes a supplemental heating element associated with the reductant tank. The supplemental heating element includes a resistive filament. The supplemental heating element also includes a housing. The housing is connected to the resistive filament. The housing is configured to be coupled to a drain port of the reductant tank. The supplemental heating element also includes a receptacle provided on the housing. The receptacle is configured to be connected to an external power supply.

In yet another aspect of the present disclosure, a method for controlling a temperature of a reductant in a reductant tank is disclosed. The method includes coupling a heating element to a drain port of the reductant tank. The method also includes connecting the heating element to an external power supply. The method further includes thawing the reductant based on the connection.

Other features and aspects of this disclosure will be apparent from the following description and the accompanying drawings.

### BRIEF DESCRIPTION OF THE DRAWINGS

FIG. 1 is a block diagram of an exemplary engine system including an engine and an aftertreatment system, according to one embodiment of the present disclosure;

FIG. 2 is a perspective view of a reductant tank;

FIG. 3 is a perspective view of an exemplary heating element; and

FIG. 4 is a method for controlling a temperature of a reductant in the reductant tank.

### DETAILED DESCRIPTION

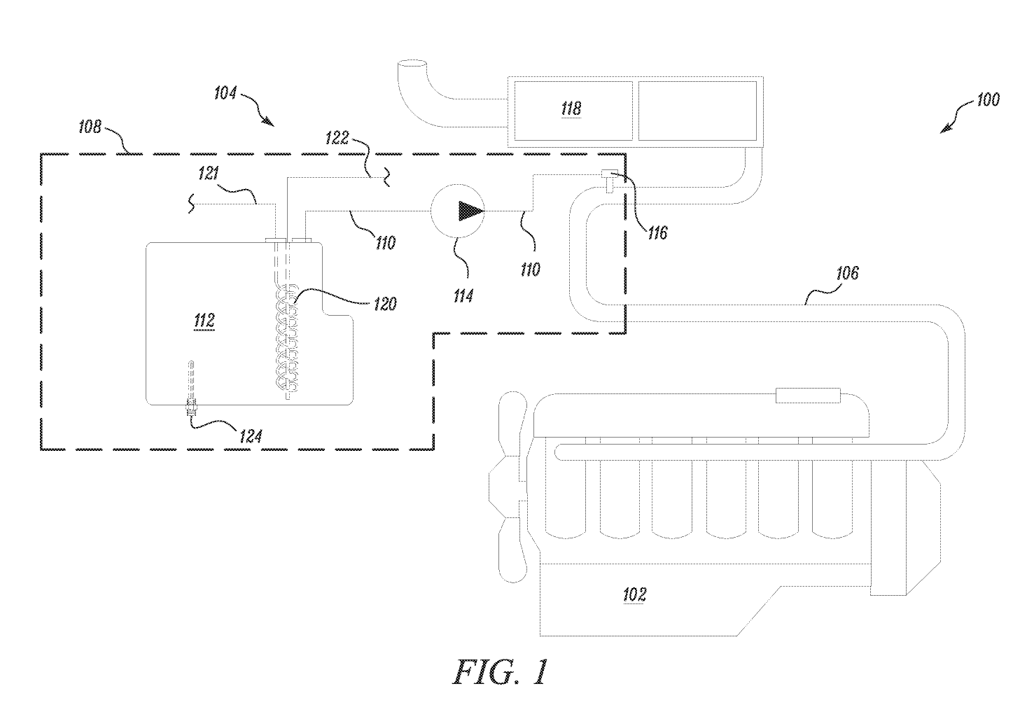

Reference will now be made in detail to specific embodiments or features, examples of which are illustrated in the accompanying drawings. Generally, corresponding or similar reference numbers will be used, when possible, to refer to the same or corresponding parts. Referring to FIG. 1, a block diagram of an exemplary engine system 100 is illustrated. The engine system 100 includes an engine 102. In one embodiment, the engine 102 may include any internal combustion engine known in the art including, but not limited to, a diesel-fueled engine, a gasoline-fueled engine, a natural gas-fueled engine or a combination thereof. The engine 102 may include other components, such as, a fuel system, an intake system, a drivetrain including a transmission system and so on. The engine 102 may be used to provide power to any machine including, but not limited to, an on-highway truck, an off-highway truck, an earth moving machine and other similar machines.

The engine system 100 also includes an exhaust aftertreatment system 104. The aftertreatment system 104 is fluidly connected to an exhaust manifold 106 of the engine 102. The aftertreatment system 104 is configured to treat an exhaust gas flow exiting the exhaust manifold 106 of the engine 102. The exhaust gas flow contains emission compounds that may include Nitrogen Oxides (NOx), unburned hydrocarbons, particulate matter and/or other compounds. The aftertreatment system 104 is configured to treat and reduce NOx and/or other compounds of the emissions prior to the exhaust gas flow exiting the engine system 100.

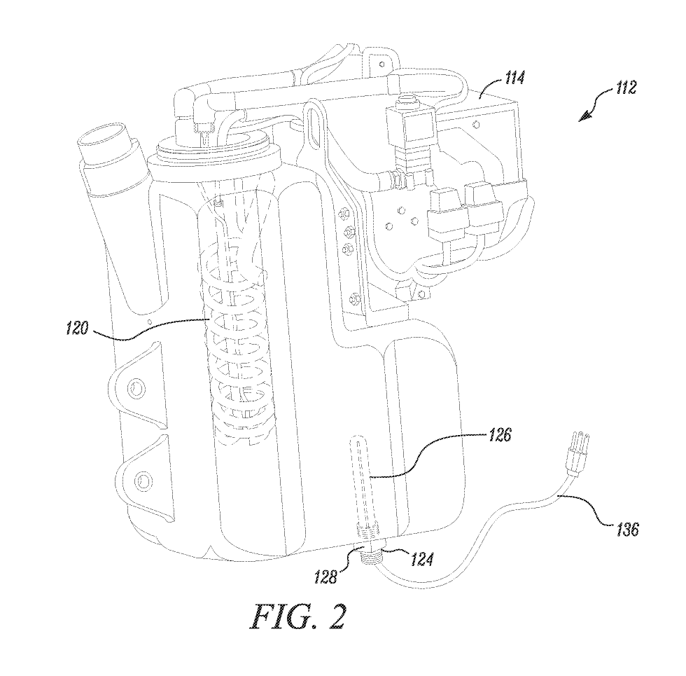

The aftertreatment system 104 includes a reductant delivery module 108. The reductant delivery module 108 is configured to inject a reductant into the exhaust gas flow. The reductant may be a fluid such as a Diesel Exhaust Fluid (DEF), including urea. Alternatively, the reductant may include ammonia or any other reducing agent. The reductant may flow through flow passages 110. The reductant delivery module 108 includes a reductant tank 112, a pump 114 and a reductant injector 116, and will be explained in detail in connection with FIG. 2. The aftertreatment system 104 may further include a Selective Catalytic Reduction (SCR) module 118 provided downstream of the reductant delivery module 108 with respect to a reductant flow direction in the aftertreatment system 104. The SCR module 118 is configured to reduce a concentration of NOx present in the exhaust gas flowing therethrough.

The aftertreatment system 104 disclosed herein is exemplary. A person of ordinary skill in the art will appreciate that the aftertreatment system 104 may additionally include other components. For example, in one embodiment, the aftertreatment system 104 may also include a mixing chamber (not shown) fluidly connected to the exhaust manifold 106 and the SCR module 118. The mixing chamber is configured to mix the exhaust gas flow received from the exhaust manifold 106 and the reductant received from the reductant tank 112 upstream of the SCR module 118. Optionally, the aftertreatment system 104 may include a Diesel Oxidation Catalyst (DOC) and/or a Diesel Particulate Filter (DPF) present upstream of the SCR module 118 with respect to the exhaust gas flow. The aforementioned variations in design of the aftertreatment system 104 are possible without deviating from the scope of the disclosure and various other configurations not disclosed herein are also possible within the scope of this disclosure.

FIG. 2 illustrates a perspective view of the reductant tank 112. The reductant tank 112 is configured to store the reductant. In one embodiment, the reductant tank 112 may be a DEF tank for storage of the DEF therein. Parameters related to the reductant tank 112 such as size, shape, location, and material used may vary as function system design and requirements. As shown in FIG. 1, the reductant tank 112 is fluidly connected to the pump 114.

The pump 114 is configured to pressurize and selectively deliver the reductant from the reductant tank 112. The reductant is then introduced into the exhaust gas flow by the reductant injector 116 installed downstream of the pump 114. The pump 114 may include any pump known in the art including, but not limited to, a piston pump and a centrifugal pump. A drain port (not seen) is provided at a bottom portion of the reductant tank 112. The drain port is embodied as a hole or an opening provided at the bottom portion of the reductant tank 112.

The reductant stored in the reductant tank 112 is susceptible to freezing. For example, for machines operating in relatively cold environments, the reductant stored in the reductant tank 112 may tend to freeze. Heating systems are associated with the reductant tank 112 in order to control a temperature of the reductant stored therein. The machine may include a primary heater for the controlling of the temperature of the reductant in the reductant tank 112. The primary heater may be embodied as a coolant heater.

As shown in FIG. 2, a heat exchanger 120 may be provided within the reductant tank 112. The heat exchanger 120 may allow a coolant to flow therethrough. Flow passages 121, 122 may be provided in the reductant delivery module 108. In the accompanying figures, the flow passages 121, 122 are represented in the form of broken lines. The flow passage 121 may introduce the coolant into the heat exchanger 108. Whereas, the coolant may leave the heat exchanger 108 via the flow passage 122.

The flow passage 121 may receive the coolant leaving the engine 102 and various other components of the engine system 100. The coolant may then flow through the heat exchanger 120. The coolant heater may include a coolant pump, a valve and other known components that may be present upstream of the coolant tank, for the circulation of the coolant through the heat exchanger 120. During an operation of the engine 102, the coolant may circulate through the heat exchanger 120. The coolant flowing through the heat exchanger 120 is generally at a temperature which is higher than that of the reductant in the reductant tank 112. This high temperature of the coolant is due to heat transfer between the coolant and various engine parts. Hence, heat exchange between the coolant and the reductant may cause the reductant to thaw. Further, the coolant may exit the heat exchanger 120 of the reductant tank 112 through the flow passage 122. In one example, the coolant may flow to other parts of the system, for example, the pump 114.

It should be noted that an operation of the coolant heater disclosed herein is dependent on the operation of the engine 102 and the flow of the coolant through various components of the engine system 100 when the engine 102 is running. In some situations, the thawing of the reductant in the reductant tank 112 may be a time consuming process based on factors such as, the temperature of the reductant and/or the temperature of the coolant. In one example, the time taken to thaw the reductant may be as high as 90 minutes. The slow thawing of the reductant may affect overall system performance in instances when a dosing demand of the reductant is not met.

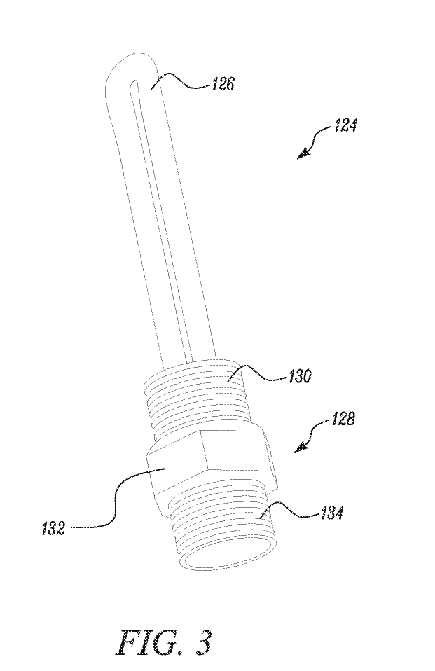

A supplemental heating element, hereinafter referred to as heating element 124, is disclosed herein, which may be installed within the reductant tank 112 in addition to the heat exchanger 120. Referring to FIGS. 2 and 3, the heating element 124 may be removably attached to the drain port of the reductant tank 112. For example, when the reductant within the reductant tank 112 is to be drained out for replacement purposes, the heating element 124 may be uninstalled from the reductant tank 112.

The heating element 124 includes a resistive filament 126. On passage of electricity therethrough, the resistive filament 126 is configured to increase a temperature of the reductant which is present within the reductant tank 112 and surrounds the heating element 124. It should be noted that the resistive filament 126 is configured to be in contact with the reductant and is therefore made from a suitable material. The material of the heating element 124 is such that the heating element 124 exhibits high conductivity and low resistivity, such that on the passage of electricity therethrough, the heating element 124 may thaw the reductant in a short time. A person of ordinary skill in the art will appreciate that the amount of time taken by the resistive filament 126 to thaw the reductant may depend on a volume of the reductant to be thawed and also on a power rating and dimensions of the resistive filament 126. Accordingly, parameters related to the resistive filament 126 namely, the power rating and dimensions may vary based on the application.

The resistive filament 126 may be made of a metal or a ceramic. In one example, the resistive filament 126 may be made of steel, for example, stainless steel. Alternatively, the resistive filament 126 may include copper or mild steel. In one embodiment, the resistive filament 126 may be coated with an anti-corrosive coating in order to avoid a corrosion of the resistive filament 126. In the accompanying figures, the resistive filament 126 has a U-shaped design, such that a length of the heating element 124 extends into the reductant tank 112 when installed thereon.

The heating element 124 includes a housing 128. The resistive filament 126 of the heating element 124 is configured to be attached to one end 130 of the housing 128. A person of ordinary skill in the art will appreciate that the resistive filament 126 may be attached to the housing 128 using any mechanical means known in the art. In one example, the resistive filament 126 may be welded to the housing 128. Alternatively, the resistive filament 126 may be threadably coupled to the housing 128 by means of threads provided on the end 130 of the resistive filament 126 and an interior facing surface of the end 130 of the housing 128 respectively. The housing 128 disclosed herein may be made of any metal, ceramic or polymer known in the art. Further, the housing 128 includes an intermediate portion 132. The intermediate portion 132 may have a chamfered outer surface for easy handling of the heating element 124 during installation and removal.

As discussed earlier, the heating element 124 is configured to be coupled to the reductant tank 112 such that the resistive filament 126 is completely received within the reductant tank 112. Accordingly, the end 130 of the housing 128 that receives the resistive filament 126 is configured to be coupled to the drain port of the reductant tank 112. The end 130 of the housing 128 may have a circular configuration. Further, an outer diameter of the end 130 of the housing 128 is substantially equal to a diameter of the drain port. In one embodiment, as shown in the accompanying figures, the end 130 of the housing 128 includes a plurality of threads provided on an exterior facing surface. The threads provided on the end 130 of the housing 128 are configured to be engaged with corresponding threads provided on the drain port in order to threadably couple the heating element 124 with the reductant tank 112. Alternatively, the heating element 124 may be coupled to the drain port of the reductant tank 112 by any other means known in the art.

A receptacle 134 is provided on the housing 128 of the heating element 124. The receptacle 134 may have a circular configuration with threads provided thereon. The receptacle 134 is configured to connect to an external power supply in order to provide electricity to the resistive filament 126. In one embodiment, the heating element 124 may be plugged to the external power supply via a cord 136.

The term “external power supply” used herein refers to the supply of electricity from a source outside that of the system on which the reductant tank 112 is installed. More particularly, the power supply to the resistive filament 126 is independent of the operation of the engine 102. Accordingly, the resistive filament 126 is operable even during a non-operational state of the engine 102. The power supply may be an AC electric power supply. In one example, a 110 Volt AC power supply may be provided to the heating element 124. Alternatively, the heating element 124 may also be powered by batteries.

### INDUSTRIAL APPLICABILITY

The reductant delivery module 108 of the aftertreatment system 104 includes the reductant flowing therethrough. The reductant is susceptible to freezing at temperatures of approximately −11° C. or below. In cold operating environments, if the machine is kept idle, the reductant in the reductant tank 112 may freeze. Further, once the machine is started, the coolant heater alone may take up to 90 minutes to thaw the reductant. In a situation wherein the dosing demand is high and the reductant is not completely thawed, an overall performance of the aftertreatment system 104 may be affected

The present disclosure includes the heating element 124 installed in addition to the coolant heater for the reductant tank 112. The heating element 124 is configured to be removably attached to the reductant tank 112 of the aftertreatment system 104. Since the heating element 124 disclosed herein is powered by the external power supply, the operation of the heating element 124 is independent of the operation of the machine or the engine 102.

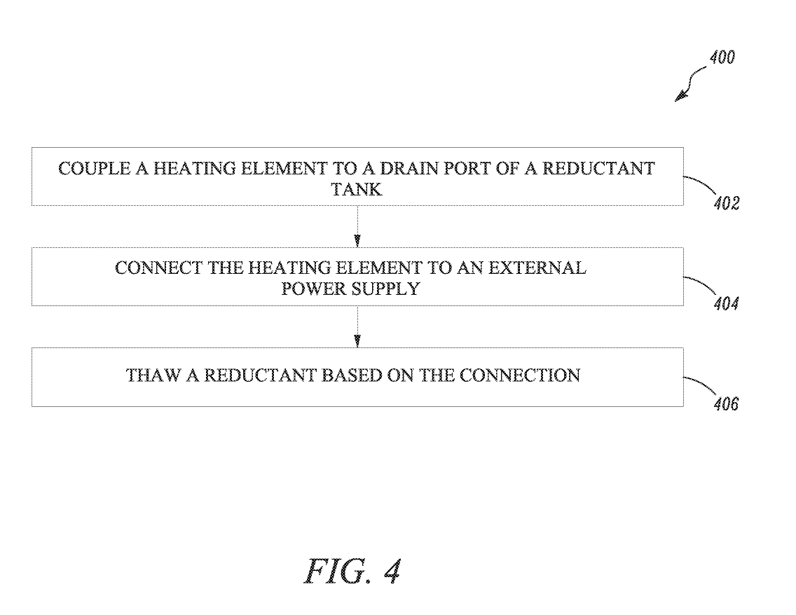

FIG. 4 is a flowchart for a method 400 of controlling the temperature of the reductant in the reductant tank 112. At step 402, the heating element 124 is coupled to the drain port of the reductant tank 112. At step 404, the heating element 124 is connected to the external power supply. At step 406, the reductant within the reductant tank 112 is thawed based on the connection of the heating element 124 with the external power supply. Additionally, during the operation of the machine, the reductant within the reductant tank 112 may be thawed by the coolant circulating through the reductant tank 112.

In one embodiment, the heating element 124 may be uninstalled from the drain port of the reductant tank 112. The reductant within the reductant tank 112 may be drained based on the uninstallation of the heating element 124. Further, the reductant tank 112 of the present disclosure is configured to receive a drain plug in place of the heating element 124. Accordingly, in environments wherein a supplemental heating system is not required for thawing the reductant within the reductant tank 112, the heating element 124 may be replaced by the drain plug.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A removable heating element comprising:
a resistive filament;
a housing connected to the resistive filament, the housing configured to couple to a drain port of a reductant tank; and
a receptacle provided on the housing, the receptacle configured to connect to an external power supply.

2. The removable heating element of claim 1, wherein the resistive filament is made of at least one of copper or steel.

3. The removable heating element of claim 1 further comprising:
an anti-corrosive coating provided on the resistive filament.

4. The removable heating element of claim 1, wherein the housing includes a number of threads corresponding to a plurality of threads provided on the drain port.

5. The removable heating element of claim 1, wherein the removable heating element is positioned at a bottom portion of the reductant tank.

6. An aftertreatment system comprising:
a reductant tank;
a coolant heater associated with the reductant tank, the coolant heater configured to circulate a coolant through the reductant tank; and
a supplemental heating element associated with the reductant tank, the supplemental heating element comprising:
a resistive filament;
a housing connected to the resistive filament, the housing configured to couple to a drain port of the reductant tank; and
a receptacle provided on the housing, the receptacle configured to connect to an external power supply.

7. The aftertreatment system of claim 6, wherein the resistive filament is made of at least one of copper or steel.

8. The aftertreatment system of claim 6, wherein the heating element further comprises an anti-corrosive coating provided on the resistive filament.

9. The aftertreatment system of claim 6, wherein the supplemental heating element is positioned at a bottom portion of the reductant tank.

10. The aftertreatment system of claim 6, wherein the supplemental heating element is threadably coupled to the reductant tank.

11. A method for controlling a temperature of a reductant in a reductant tank, the method comprising:
coupling a heating element to a drain port of the reductant tank;
connecting the heating element to an external power supply; and
thawing the reductant based on the connection.

12. The method of claim 9, wherein supplying the power to the supplemental heating element is independent of an operation of an engine.

13. The method of claim 9 further comprising:
circulating a coolant through the reductant tank.

14. The method of claim 9 further comprising;
uninstalling the heating element from the drain port of the reductant tank.

15. The method of claim 12 further comprising:
draining the reductant from the reductant tank based on the uninstallation of the heating element.
